(19) United States
(12) Patent Application Publication
(10) Pub. No.: US 2015/0026664 A1
(43) Pub. Date: Jan. 22, 2015

(54) METHOD AND SYSTEM FOR AUTOMATED TEST CASE SELECTION

(71) Applicant: International Business Machines Corporation, Armonk, NY (US)

(72) Inventors: Timothy S. Bartley, Worongary (AU); Gavin G. Bray, Robina (AU); Elizabeth M. Hughes, Currumbin Valley (AU); Kalvinder P. Singh, Miami (AU)

(21) Appl. No.: 13/944,012

(22) Filed: Jul. 17, 2013

(51) Int. Cl. G06F 11/36

(52) U.S. Cl. CPC G06F 11/3676
USPC 717/124

(57) ABSTRACT

A computer-implemented method, computer program product, and computer system for intellectually and automatically selecting test cases for testing software that has been changed. In this invention, the automated selection of the subset of the test cases is based on determination of what software under test has been changed, what test cases have exercised these changes, what test data has been used to exercise these changes, what test environment including hardware and software configuration has been used to test these changes, and what pre-requisite test cases have been run prior to having the software under test in the correct state.

### FIELD OF THE INVENTION

The present invention relates generally to software testing, and more particularly to a system and method for automatically selecting test cases for testing software that has been changed.

### BACKGROUND

Best practice of software engineering mandates that software should be thoroughly tested before the software is released. Automated software testing is the most cost effective approach. The automated software testing can involve hundreds to thousands of test cases, and each of the test cases includes a combination of test code, test data, and test configuration required to execute the automated software testing. The each of the test cases tests some aspects of software under test.

When changes are made to the software, testing the software with the changes is an important but difficult task, especially as the complexity of the software under test and the number of the test cases increase. A first existing solution is to run all the test cases. Running all the test cases to test the software with the changes is not feasible, due to time and resource constraints. In addition, in the first existing solution, feedback to a development team is delayed. A second existing solution is to manually select a subset of the test cases. The second existing solution requires testers to identify some cases for testing the software with the changes. The second existing solution is time consuming for the testers and prone to errors. A third existing solution is to select test cases based on code coverage metrics only and thus is only a partial solution.

### BRIEF SUMMARY

Embodiments of the present invention provide a computer-implemented method, computer program product, and computer system for selecting test cases for testing software that has been changed. The computer system executes one or more test cases with one or more test case input data, one or more test environments, and one or more prerequisite test cases. The computer system generates, for the software, code coverage metrics which describes what code of the software has been executed. The computer system generates, for the software, code change metrics which describes what changes to the software have been made. Based on a correlation between the code coverage metrics and the code change metrics, the computer system determines the changes to the software. From the one or more test cases, the computer system selects test cases corresponding to the changes.

### BRIEF DESCRIPTION OF THE SEVERAL VIEWS OF THE DRAWINGS

FIG. 1 is a diagram illustrating an exemplary system for automatically selecting test cases for testing software under test, in accordance with an exemplary embodiment of the present invention.

FIG. 2 is a flowchart illustrating operational steps of a test case selection program shown in FIG. 1, in accordance with an exemplary embodiment of the present invention.

FIG. 3 is a diagram illustrating components of a computing device hosting the exemplary system shown in FIG. 1, in accordance with an exemplary embodiment of the present invention.

### DETAILED DESCRIPTION

The present invention describes a method and system for intelligently and automatically identifying a subset of test cases for testing software that has been changed. The automated selection of the subset of the test cases is based on determination of what software under test has been changed, what test cases have exercised these changes, what test data has been used to exercise these changes, what test environment including hardware and software configuration has been used to test these changes, and what pre-requisite test cases have been run prior to having the software under test in the correct state. The determination of those mentioned above is automated. The advantages of the present invention include error free, more efficient use of time and resources, fast and more relevant feedback to a development team, and taking account of dependencies in the test data, the test environment, and prerequisite test cases.

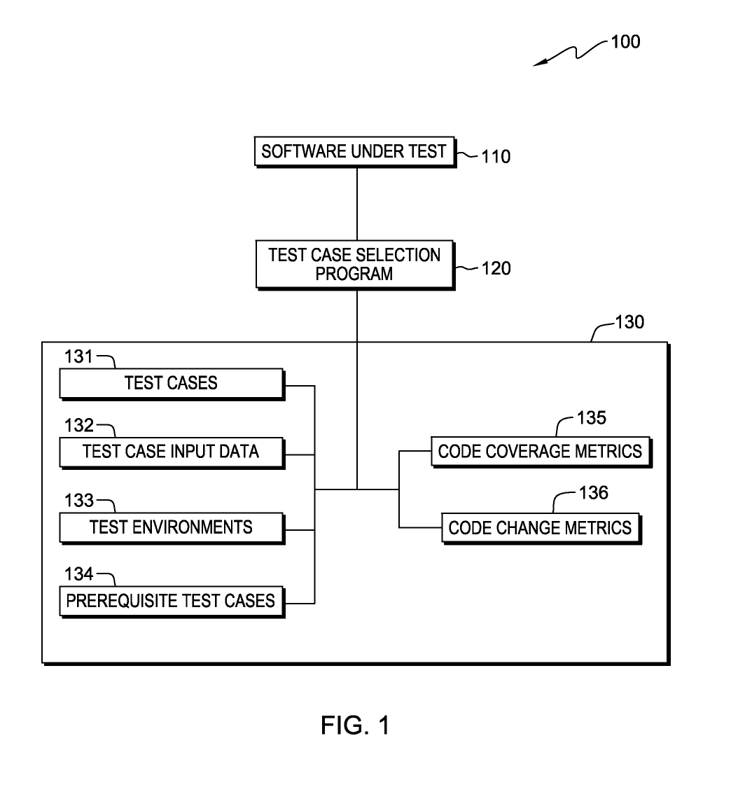

FIG. 1 is a diagram illustrating exemplary system 100 for automatically selecting test cases for testing software under test 110, in accordance with an exemplary embodiment of the present invention. Exemplary system 100 includes test case selection program 120. Test case selection program 120 identifies test cases for testing software under test 110 that has been changed since the last testing. Test case selection program 120 selects a subset of test cases from test cases 131 on database 130. The subset of test cases are selected to correspond to changes made to software under test 110 and are to be executed for testing software under test 110 that has been changed. Database 130 includes code coverage metrics 135 for software under test 110. To generate code coverage metrics 135 for software under test 110, test case selection program 120 executes test cases chosen from test cases 131 on database 130 against software under test 110. Before executing the test cases chosen from test cases 131, test case selection program 120 runs prerequisite test case(s) chosen from prerequisite test cases 134 on database 130 to establish a correct initial state of software under test 110. Test case selection program 120 executes the test cases chosen from test cases 131 with the test case input data chosen from test case input data 132 on database 130. Test case selection program 120 executes the test cases with different test case input data selected from test case input data 132; execution with the different test case input data may produce quite distinct test case scenarios even though the test case code is the same. Test case selection program 120 executes the test cases within different test environments chosen from test environments 133 on database 130. Each test environment may produce quite distinct test case scenarios even though the test case code is the same. A test environment is a setup of software and hardware on which software under test 110 is to be tested.

Referring to FIG. 1, on database 130, code coverage metrics 135 for software under test 110 describes what code of software under test 110 has been executed. The levels of granularity of code coverage metrics 135 include methods, statements, and condition coverage. Code coverage metrics 135 is sometimes used to formulate test cases 131. For example, if code coverage metrics 135 indicates a certain function hasn't been executed, then some test cases to execute the function may be developed in test cases 131. Test case selection program 120 maps code coverage metrics 135 to a combination of test cases 131, test case input data 132, test environments 133, and prerequisite test cases 134. In the exemplary embodiment, based on code coverage metrics 135, test case selection program 120 determines code coverage information. The level of granularity of the code coverage metrics determines the precision of the code coverage information. The code coverage information is listed as follows. (1) For a test case chosen from test cases 131, sections of software under test 110 exercised by the test case are listed. The test case is exercised with its related test case input data chosen from test case input data 132, its test environment(s) chosen from test environments 133, and its related prerequisite test case(s) chosen from prerequisite test cases 134. For example, if the level of granularity is method coverage, then methods in software under test 110 exercised by the test case are listed. (2) For an identified section of software under test 110, an exercise is done by certain test cases chosen from test cases 131 with certain test case input data chosen from test case input data 132, test environments chosen from test environments 133, and certain prerequisite test cases chosen from prerequisite test cases 134. For the identified section, the exercise is listed. For example, if the level of granularity is method coverage, the exercise of the method is listed. (3) Under a test without a test case, sections of software under test 110 are listed for at least one of the following: certain test case input data chosen from test case input data 132, certain test environments chosen from test environments 133, and certain prerequisite test cases chosen from prerequisite test cases 134. (4) For a case in which sections of software under test 110 are exercised by more than one test case chosen from test cases 131, the sections are listed for duplicated or overlapping test cases with their related test case input data chosen from test case input data 132, their test environment(s) chosen from test environments 133, and their related prerequisite test case(s) chosen from prerequisite test cases 134. Having executed the test cases chosen from test cases 131, test case selection program 120 updates, on database 130, code coverage metrics 135 which is mapped to the combination of test cases 131, test case input data 132, test environments 133, and prerequisite test cases 134.

Referring to FIG. 1, database 130 includes code change metrics 136. Code change metrics 136 describes what changes to source code, configuration, and other associated information of software under test 110 have been made. The levels of granularity of code change metrics 136 include methods, statements, and condition coverage. Test case selection program 120 generates code change metrics 136 on database 130. Using code change metrics 136, test case selection program 120 determines the following information. The sections of software under test 110 that has been changed within a certain time period are listed. For example, if the level of granularity is method coverage, then methods in software under test 110 that has been changed in the last 24 hours are listed. Based on code change metrics 136, test case selection program 120 determines changes to software under test 110. By correlating code coverage metrics 135 and code change metrics 136, test case selection program 120 determines a subset of test cases 131; the subset includes test cases corresponding to the changes. The test cases of the subset are to be run for testing software under test 110 that has been changed.

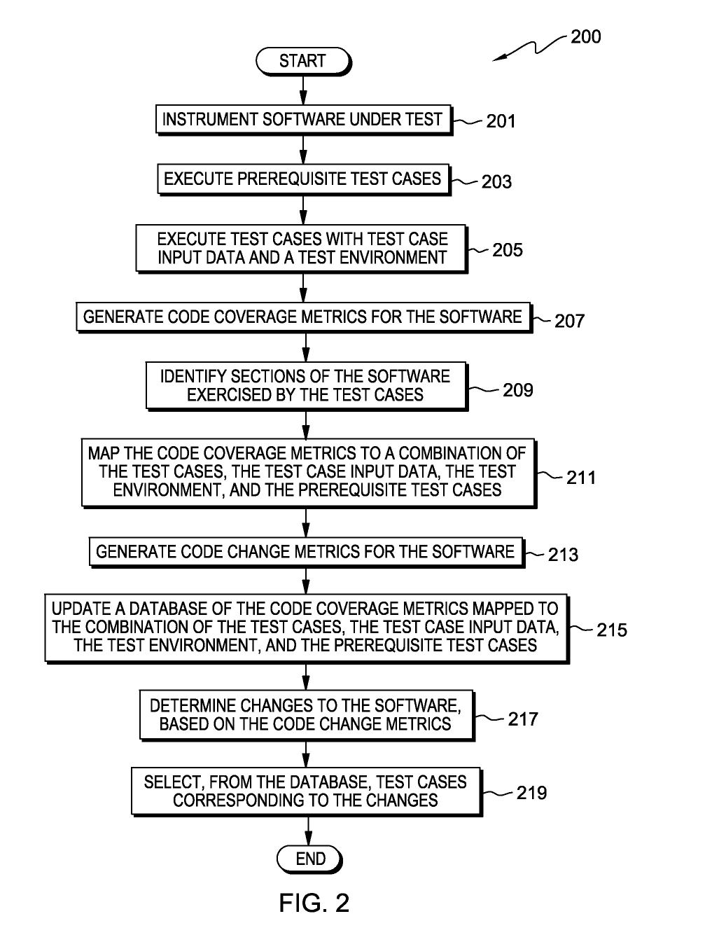

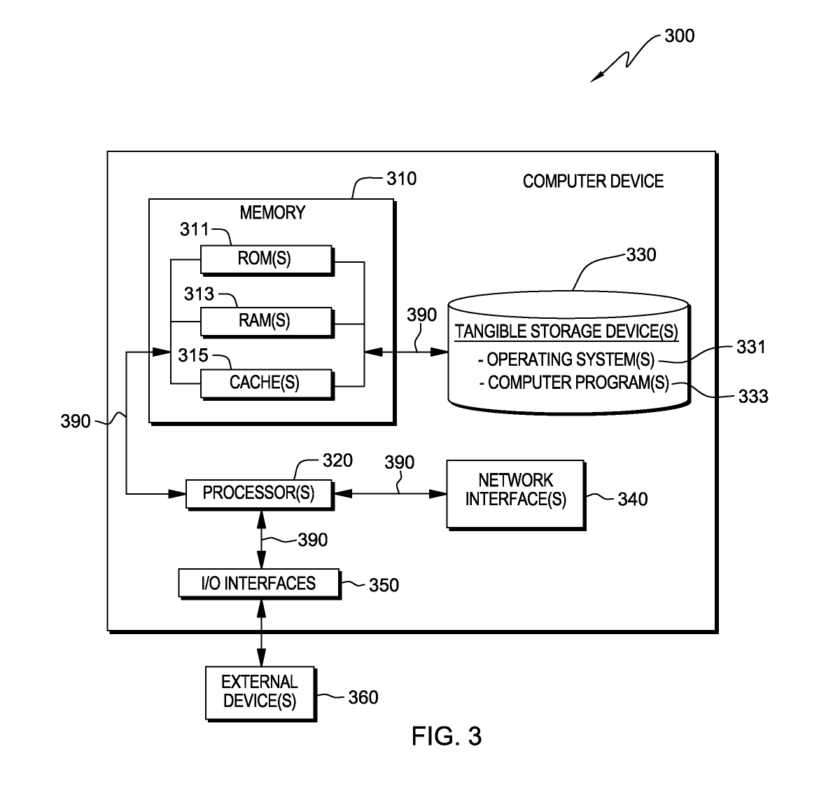

FIG. 2 is flowchart 200 illustrating operational steps of test case selection program 120 shown in FIG. 1, in accordance with an exemplary embodiment of the present invention. In the exemplary embodiment, test case selection program 120 is run for automatically selecting a subset of test cases 131 (shown in FIG. 1) for software under test 110 (shown in FIG. 1) that has been changed. In the exemplary embodiment, test case selection program 120 is hosted on a computer device shown in FIG. 3.

At step 201, test case selection program 120 instruments software under test 110 that has been changed since the last testing. Software under test 110 is instrumented so that code coverage metrics 135 on database 130 (shown in FIG. 1) can be generated. At step 203, test case selection program 120 executes one or more prerequisite test cases chosen from prerequisite test cases 134 on database 130 (shown in FIG. 1). Executing the one or more prerequisite test cases, test case selection program 120 establishes a correct initial state of software under test 110. At step 205, test case selection program 120 executes test cases chosen from test cases 131 on database 130 (shown in FIG. 1). Each of the test cases is executed with its test case input data chosen from test case input data 132 on database 130 (shown in FIG. 1) and under its one or more test environments chosen form test environments 133 on database 130 (shown in FIG. 1).

At step 207, test case selection program 120 generates code coverage metrics 135 for software under test 110. Code coverage metrics 135 describes what code of software under test 110 has been executed. The levels of granularity of code coverage metrics 135 include methods, statements, and condition coverage. Numerous tools are available for test case selection program 120 to collect the information of code coverage, such as Rational® Purify® which is a dynamic software analysis tool developed by International Business Machines Corporation (IBM®) and is supported on Windows®, Linux®, Solaris®, and AIX®. In addition, software under test 120 may use static analysis tools to determine dependencies in software under test 110.

At step 209, based on code coverage metrics 135 generated at step 207, test case selection program 120 identifies, in software under test 110, sections exercised by the test cases executed at step 205. Through this step, the code coverage information is determined. The code coverage information is listed in a previous paragraph in this document.

At step 211, test case selection program 120 maps code coverage metrics 135 to a combination of test cases 131, test case input data 132, test environments 133, and prerequisite test cases 134.

At step 213, test case selection program 120 generates code change metrics 136 (shown in FIG. 1) for software under test 110. Code change metrics 136 is on database 130 and describes what changes have been made to source code, configuration, and other associated information of software under test 110. To generate code change metrics 136, test case selection program 120 uses configuration management tools and version control systems. Test case selection program 120 may additionally use the dependencies determined by static analysis tools at step 207 to generate code change metrics 136. For example, if a library method that software under test 110 depends on has been changed, test case selection program 120 includes, in code change metrics 136, all code calling the library method in software under test 110.

At step 215, test case selection program 120 updates database 130 including code coverage metrics 135 mapped to the combination of test cases 131, test case input data 132, test environments 133, and prerequisite test cases 134.

At step 217, based on code change metrics 136 generated at step 213, test case selection program 120 determines changes to software under test 110. Given a time and date, sections of software under test 110 that has been changed in the intervening time period are listed. For example, if the level of granularity is method coverage, then the method in software under test 110 that has been changed in the last 24 hours is listed.

At step 219, test case selection program 120 selects, from database 130 updated at step 215, test cases corresponding to the changes determined at step 217. At this step, selecting the test cases corresponding to the changes is based on correlation between code coverage metrics 135 and code change metrics 136. The test cases corresponding to the changes are selected as a subset of test cases 131 on database 130. The test cases corresponding to the changes are to be run for testing software under test 110 that has been changed.

FIG. 3 is a diagram illustrating components of computing device 300 hosting the exemplary system shown in FIG. 1, in accordance with an exemplary embodiment of the present invention. It should be appreciated that FIG. 3 provides only an illustration of one implementation and does not imply any limitations with regard to the environment in which different embodiments may be implemented.

Referring to FIG. 3, computing device 300 includes processor(s) 320, memory 310, tangible storage device(s) 330, network interface(s) 340, and I/O (input/output) interface(s) 350. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315.

One or more operating systems 331 and one or more computer programs 333 reside on one or more computer-readable tangible storage device(s) 330. In the exemplary embodiment, exemplary system 100, including test case selection program 120 and database 130, resides on one or more computer-readable tangible storage device(s) 330. In other embodiments, test case selection program 120 and database 130 reside respectively on multiple computer devices which are connected by a network. In further other embodiments, different components on database 130, including test cases 131, test case input data 132, test environments 133, prerequisite test cases 134, code coverage metrics 135, and code change metrics 136, reside respectively on multiple computer devices which are connected by a network.

Computing device 300 further includes I/O interface(s) 350. I/O interface(s) 350 allow for input and output of data with external device(s) 360 that may be connected to computing device 300. Computing device 300 further includes network interface(s) 340 for communications between computing device 300 and a computer network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, and micro-code) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF (radio frequency), and any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer-implemented method for selecting test cases for testing software that has been changed, the method comprising:
executing one or more test cases with one or more test case input data, one or more test environments, and one or more prerequisite test cases;
generating code coverage metrics for the software, code coverage metrics describing what code of the software has been executed;
mapping the code coverage metrics to a combination of the one or more test cases, the one or more test case input data, the one or more test environments, and the one or more prerequisite test cases;
generating code change metrics for the software, code change metrics describing what changes to the software have been made;
updating a database which maps the changes to the one or more test cases, the one or more test case input data, the one or more test environments, and the one or more prerequisite test cases;
determining the changes to the software, based on a correlation between the code coverage metrics and the code change metrics; and
selecting, from the one or more test cases, test cases for testing the software that has been changed.

2. (canceled)

3. (Canceled)

4. The computer-implemented method of claim 3, wherein the database comprises the one or more test cases, the one or more test case input data, the one or more test environments, the one or more prerequisite test cases, the code coverage metrics, and the code change metrics.

5. The computer-implemented method of claim 1, wherein levels of granularity of the code coverage metrics and the code change metrics include methods, statements, and condition coverage.

6. The computer-implemented method of claim 1, further comprising the step of: identifying, in the software, sections executed by the one or more test cases, based on the code coverage metrics

7. A computer program product for selecting test cases for testing software that has been changed, the computer program product comprising a computer readable storage medium having program code embodied therewith, the program code executable to:
execute one or more test cases with one or more test case input data, one or more test environments, and one or more prerequisite test cases;
generate code coverage metrics for the software, code coverage metrics describing what code of the software has been executed;
map the code coverage metrics to a combination of the one or more test cases, the one or more test case input data, the one or more test environments, and the one or more prerequisite test cases;
generate code change metrics for the software, code change metrics describing what changes to the software have been made;
update a database which maps the changes to the one or more test cases, the one or more test case input data, the one or more test environments, and the one or more prerequisite test cases;
determine the changes to the software, based on a correlation between the code coverage metrics and the code change metrics; and
select, from the one or more test cases, test cases for testing the software that has been changed.

8. (canceled)

9. (canceled)

10. The computer program product of claim 9, wherein the database comprises the one or more test cases, the one or more test case input data, the one or more test environments, the one or more prerequisite test cases, the code coverage metrics, and the code change metrics.

11. The computer program product of claim 7, wherein levels of granularity of the code coverage metrics and the code change metrics include methods, statements, and condition coverage.

12. The computer program product of claim 7, further comprising the program code executable to identify, in the software, sections exercised by the one or more test cases, based on the code coverage metrics.

13. A computer system for selecting test cases for testing software that has been changed, the computer system comprising:
one or more processors, one or more computer-readable tangible storage devices, and program instructions stored on at least one of the one or more computer-readable tangible storage devices for execution by at least one of the one or more processors, the program instructions executable to:
execute one or more test cases with one or more test case input data, one or more test environments, and one or more prerequisite test cases;
generate code coverage metrics for the software, code coverage metrics describing what code of the software has been executed;
map the code coverage metrics to a combination of the one or more test cases, the one or more test case input data, the one or more test environments, and the one or more prerequisite test cases;
generate code change metrics for the software, code change metrics describing what changes to the software have been made;
update a database which maps the changes to the one or more test cases, the one or more test case input data, the one or more test environments, and the one or more prerequisite test cases;
determine the changes to the software, based on a correlation between the code coverage metrics and the code change metrics; and
select, from the one or more test cases, test cases for testing the software that has been changed.

14. (canceled)

15. (canceled)

16. The computer system of claim 15, wherein the database comprises the one or more test cases, the one or more test case input data, the one or more test environments, the one or more prerequisite test cases, the code coverage metrics, and the code change metrics.

17. The computer system of claim 13, wherein levels of granularity of the code coverage metrics and the code change metrics include methods, statements, and condition coverage.

18. The computer system of claim 13, further comprising the program instructions executable to identify, in the software, sections exercised by the one or more test cases, based on the code coverage metrics.
